(19) United States
(12) Patent Application Publication
(10) Pub. No.: US 2022/0341003 A1
(43) Pub. Date: Oct. 27, 2022

(54) NICKEL-BASED ALLOY FOR ADDITIVE MANUFACTURING, METHOD AND PRODUCT

(71) Applicant: Siemens Energy Global GmbH & Co. KG, Munich (DE)

(72) Inventors: Magnus Hasselqvist, Finspong (SE); Christoph Heinze, Markkleeberg (DE); Yves Küsters, Berlin (DE); Henrik Ruul, Norrköping (SE)

(73) Assignee: Siemens Energy Global GmbH & Co. KG, Munich, Bayern (DE)

(21) Appl. No.: 17/640,683

(22) PCT Filed: Sep. 2, 2020
(86) PCT No.: PCT/EP2020/074479

§ 371 Date: Jul. 17, 2022

(30) Foreign Application Priority Data
Sep. 13, 2019 (DE) 10 2019 213 990.6

(51) Int. Cl. C22C 19/05; B33Y 70/00; B33Y 10/00; B22F 10/28

(52) U.S. Cl. CPC C22C 19/056; B33Y 70/00; B33Y 10/00; B22F 10/28; B22F 2301/15

(57) ABSTRACT

A nickel-based alloy for additive manufacturing, method and product wherein due to a specific selection of elements and adaptations, an improved alloy for casting and for additive manufacturing is provided.

### CROSS REFERENCE TO RELATED APPLICATIONS

This application is the US National Stage of International Application No. PCT/EP2020/074479 filed 2 Sep. 2020, and claims the benefit thereof. The International Application claims the benefit of German Application No. DE 10 2019 213 990.6 filed 13 Sep. 2019. All of the applications are incorporated by reference herein in their entirety.

### FIELD OF INVENTION

The invention relates to a nickel-based alloy and to a method and also to a product, with the alloy and the product exhibiting improved properties in the case of casting and of an additive production route.

The products described are intended advantageously for use in a turbomachine, advantageously in the hot gas path of a gas turbine.

### BACKGROUND OF INVENTION

Additive production processes encompass powder bed processes (PBF) including, for example, selective laser melting (SLM) or laser sintering (SLS) or electron beam melting (EBM).

Further additive processes are, for example, directed energy deposition (DED) processes, more particularly laser deposition welding, electron beam or plasma powder welding, wire welding, metallic powder injection molding, processes known as sheet lamination processes, or thermal spraying processes (VPS, LPPS, GDCS).

A process for selective laser melting is known from EP 2 601 006 B 1, for example.

Additive manufacturing (AM) processes have also proven particularly advantageous for complex or intricate components, examples being labyrinthine structures, cooling structures and/or lightweight structures. Additive manufacturing is advantageous more particularly as a result of an especially short chain of process steps, since a step for the production or manufacture of a component can be performed largely on the basis of a corresponding CAD file and the choice of corresponding manufacturing parameters.

In the sector of fixed gas turbines there are materials requirements that often cannot be covered simultaneously by the existing materials. These requirements include appropriate or advantageous oxidation and corrosion resistance, coatability and lifetime of the coating on the substrate, advantageous mechanical properties, such as creep resistance and TMF (thermo-mechanical fatigue) resistance, and a capacity for low-cracking or crack-free processing, in relation to hot cracks or solidification cracks, with various manufacturing processes, such as casting, laser powder deposition welding and selective laser or electron beam melting from the powder bed. An inherent feature of additive manufacturing technologies particularly, and powder bed-based processes (PB F) more particularly, is the local incidence of very high temperature gradients, in some cases more than 10⁶ K/s, which are responsible for the hot cracks or solidification cracks described.

Up until now, in general, suboptimal alloys have been utilized and corresponding disadvantages—structural disadvantages, for example—of the individual alloys have been gotten around or put up with, as such problems have been solved or tolerated by design and coating and also by corresponding maintenance intervals.

### SUMMARY OF INVENTION

It is the object of the invention to solve the problems stated above and to satisfy the stated requirements.

The object is achieved by means of an alloy. in a method, and a product as claimed.

The dependent claims list further advantageous measures, which can be combined with one another as desired in order to achieve further advantages.

Notable features of the alloy are as follows: —high chromium content for corrosion resistance; —suitable capacity for processing in diverse manufacturing processes through targeted limitation of the elements (Si, Mn, B, Zr) and targeted selection of the element Hf; —moderate Al content for creep resistance and oxidation resistance; —high tantalum content for creep resistance; —Co reduction in some cases down to 0 wt %, and targeted replacement by iron (Fe) improved; —high Hf content improves coating of PtAl and strengthens beta-phase in an optional heat insulation layer; —specified composition enables large heat treatment window for less complicated heat treatments, and low incidence of imperfections during heat treatment.

The alloy comprises (figures in wt %):

| | |
|---|---|
| carbon (C) | 0.03%-0.13% |
| chromium (Cr) | 12.5%-16.0% |
| molybdenum (Mo) | 1.0%-2.0% |
| tungsten (W) | 2.0%-4.0% |
| aluminum (Al) | 4.0%-5.5% |
| boron (B) | 0.0025%-0.015% |
| zirconium (Zr) | 0.0025%-0.015% |
| tantalum (Ta) | 3.0%-7.0%, |
| more particularly | 4.0%-7.0%, |
| iron (Fe) | 3.0%-7.0% |
| hafnium (Hf) | 1.4%-2.2%, |
| and optionally further elements | |
| cobalt (Co) | 0.0%-5.0%, |
| more particularly | 0.0%-4.0%, |
| especially | 0.0%-3.0%, |
| niobium (Nb) | max. 1.0%, |
| more particularly | 0.5%-1.0%, |
| especially | 0.1% to 0.5% |
| rhenium (Re) | max. 1.0% |
| more particularly | 0.5%-1.0% |
| especially | 0.1% to 0.5% |
| silicon (Si) | max. 0.02% |
| manganese (Mn) | max. 0.05% |
| phosphorus (P) | max. 0.005% |
| sulfur (S) | max. 0.001% |
| titanium (Ti) | max. 0.2% |
| copper (Cu) | max. 0.01% |
| vanadium (V) | max. 0.1% |
| silver (Ag) | max. 0.0005% |
| lead (Pb) | max. 0.0002% |
| selenium (Se) | max. 0.0010% |
| oxygen (O) | max. 0.0200% |
| gallium (Ga) | max. 0.0030% |
| bismuth (Bi) | max. 0.0010% |
| nitrogen (N) | max. 0.0050% |
| magnesium (Mg) | max. 0.0070% |
| yttrium (Y) | max. 0.02% |
| cerium (Ce) | max. 0.02%. |

The technical advantages of the alloy presently described concern the: ⋅manufacture of gas turbine components, which is possible with little or no cracking via various manufacturing routes, in particular via casting technology, laser powder deposition welding and selective powder bed melting processes; ⋅efficiency boost to a gas turbine comprising the described components/the described alloy, and AM design; ⋅cost reduction as a result of low cobalt fractions; ⋅adaptation of the alloy elements Si, B, Zr and Hf to the process conditions, and also of Al, Fe, Ta and Hf to the mechanical and thermophysical requirements of the product, especially in terms of its creep, TMF, corrosion and oxidation resistance; ⋅manufacture of high-grade gas turbine components with a new, cost-effective alloy, so that future product/component requirements can be covered and a contribution is made to the boost in efficiency of gas turbines.

### DETAILED DESCRIPTION OF INVENTION

Some examples, though without limitation, are as follows:

| | C | Cr | Mo | Al | Hf | Co | Ta | Fe |
|---|---|---|---|---|---|---|---|---|
| 1 | 0.04 | 12.5 | 1.2 | 4.1 | 1.4 | 0 | 3.1 | 7.0 |
| 2 | 0.06 | 13.1 | 1.6 | 4.6 | 1.7 | 1 | 3.5 | 7.0 |
| 3 | 0.1 | 14.0 | 1.8 | 5.2 | 1.9 | 2 | 4.7 | 7.0 |
| 4 | 0.12 | 15.5 | 2.0 | 5.5 | 2.2 | 3 | 5.1 | 7.0 |
| 5 | 0.04 | 12.5 | 1.2 | 4.1 | 1.4 | 0 | 5.5 | 7.0 |
| 6 | 0.06 | 13.1 | 1.6 | 4.6 | 1.7 | 1 | 6.1 | 7.0 |
| 7 | 0.1 | 14.0 | 1.8 | 5.2 | 1.9 | 2 | 6.6 | 7.0 |
| 8 | 0.12 | 15.5 | 2.0 | 5.5 | 2.2 | 3 | 7.0 | 7.0 |
| 9 | 0.04 | 12.5 | 1.2 | 4.1 | 1.4 | 0 | 3.1 | 6.4 |
| 10 | 0.06 | 13.1 | 1.6 | 4.6 | 1.7 | 1 | 3.5 | 5.8 |
| 11 | 0.1 | 14.0 | 1.8 | 5.2 | 1.9 | 2 | 4.7 | 4.9 |
| 12 | 0.12 | 15.5 | 2.0 | 5.5 | 2.2 | 3 | 5.1 | 4.0 |
| 13 | 0.04 | 12.5 | 1.2 | 4.1 | 1.4 | 0 | 5.5 | 6.4 |
| 14 | 0.06 | 13.1 | 1.6 | 4.6 | 1.7 | 1 | 6.1 | 5.8 |
| 15 | 0.1 | 14.0 | 1.8 | 5.2 | 1.9 | 2 | 6.6 | 4.9 |
| 16 | 0.12 | 15.5 | 2.0 | 5.5 | 2.2 | 3 | 7.0 | 4.0 |
| 17 | 0.04 | 12.5 | 1.2 | 4.1 | 1.4 | 0 | 3.1 | 6.4 |
| 18 | 0.06 | 13.1 | 1.6 | 4.6 | 1.7 | 1 | 3.5 | 5.8 |
| 19 | 0.1 | 14.0 | 1.8 | 5.2 | 1.9 | 2 | 4.7 | 4.9 |
| 20 | 0.12 | 15.5 | 2.0 | 5.5 | 2.2 | 3 | 5.1 | 4.0 |
| 21 | 0.04 | 12.5 | 1.2 | 4.1 | 1.4 | 0 | 5.5 | 6.4 |
| 22 | 0.06 | 13.1 | 1.6 | 4.6 | 1.7 | 1 | 6.1 | 5.8 |
| 23 | 0.1 | 14.0 | 1.8 | 5.2 | 1.9 | 2 | 6.6 | 4.9 |
| 24 | 0.12 | 15.5 | 2.0 | 5.5 | 2.2 | 3 | 7.0 | 4.0 |

The values for the alloy elements not listed, W, C, B, Zr, etc., correspond to those in the above listing.

Advantages with cobalt are achieved by means of at least 0.5% cobalt (Co), more particularly 0.5% to 4.0%, especially 0.5% to 3.0%.

Further advantages are achieved by means of at least 0.5% cobalt (Co), more particularly 0.5% to 2.0%, especially 0.5% to 1.0% in the alloy.

Advantages with tantalum are achieved by means of at least 3.0 to 5.0% tantalum (Ta), more particularly 4.0% to 5.0%, especially 4.5%.

Further advantages are achieved with at least 5.1 to 7.0% tantalum (Ta), more particularly 6.0% to 7.0%, especially 6.5% in the alloy.

Advantages with iron (Fe) are achieved by means of at least 3.0 to 5.0%, more particularly 4.0% to 5.0%, especially 4.5%.

Further advantages are achieved with at least 5.1 to 7.0% iron (Fe), more particularly 6.0% to 7.0%, especially 6.5% in the alloy.

The product which comprises the alloy described is advantageously a component which is used in the hot gas path of a turbomachine, such as of a gas turbine, for example. The component more particularly may be a rotor blade or guide vane, a segment or ring-segment, a burner part or a burner tip, a frame, a shield, a heat-shield, a nozzle, a seal, a filter, an outlet or a lance, a resonator, a stamp or a swirler, or a corresponding transition, insert or a corresponding retrofitted part.

1. A nickel-based superalloy, which at least comprises, elements of (in wt %):

| | |
|---|---|
| carbon (C) | 0.03%-0.13% |
| chromium (Cr) | 12.5%-16.0% |
| molybdenum (Mo) | 1.0%-2.0% |
| tungsten (W) | 2.0%-4.0% |
| aluminum (Al) | 4.0%-5.5% |
| boron (B) | 0.0025%-0.015% |
| zirconium (Zr) | 0.0025%-0.015% |
| tantalum (Ta) | 3.0%-7.0%, |
| more particularly | 4.0%-7.0%, |
| iron (Fe) | 3.0%-7.0% |
| hafnium (Hf) | 1.4%-2.2%, |
| and optionally further elements | |
| cobalt (Co) | 0.0%-5.0%, |
| more particularly | 0.0%-4.0%, |
| especially | 0.0%-3.0%, |
| niobium (Nb) | max. 1.0%, |
| more particularly | 0.5%-1.0% |
| especially | 0.1% to 0.5% |
| rhenium (Re) | max. 1.0% |
| more particularly | 0.5%-1.0% |
| especially | 0.1% to 0.5% |
| silicon (Si) | max. 0.02% |
| manganese (Mn) | max. 0.05% |
| phosphorus (P) | max. 0.005% |
| sulfur (S) | max. 0.001% |
| titanium (Ti) | max. 0.2% |
| copper (Cu) | max. 0.01% |
| vanadium (V) | max. 0.1% |
| silver (Ag) | max. 0.0005% |
| lead (Pb) | max. 0.0002% |
| selenium (Se) | max. 0.0010% |
| oxygen (O) | max. 0.0200% |
| gallium (Ga) | max. 0.0030% |
| bismuth (Bi) | max. 0.0010% |
| nitrogen (N) | max. 0.0050% |
| magnesium (Mg) | max. 0.0070% |
| yttrium (Y) | max. 0.02% |
| cerium (Ce) | max. 0.02%. |

2. The alloy as claimed in claim 1, comprising:
at least 0.5% cobalt (Co),
more particularly 0.5% to 4.0%,
especially 0.5% to 3.0%.

3. The alloy as claimed in claim 1, comprising:
at least 0.5% cobalt (Co),
more particularly 0.5% to 2.0%,
especially 0.5% to 1.0%.

4. The alloy as claimed in claim 1, comprising:
at least 3.0 to 5.0% tantalum (Ta),
more particularly 4.0% to 5.0%,
especially 4.5%.

5. The alloy as claimed in claim 1, comprising:
at least 5.1 to 7.0% tantalum (Ta),
more particularly 6.0% to 7.0%,
especially 6.5%.

6. The alloy as claimed in claim 1, comprising:
at least 3.0 to 5.0% iron (Fe),
more particularly 4.0% to 5.0%,
especially 4.5%.

7. The alloy as claimed in claim 1, comprising:
at least 5.1 to 7.0% iron (Fe),
more particularly 6.0% to 7.0%,
especially 6.5%.

8. A method for producing or repairing a component, comprising:
using an alloy as claimed claim 1.

9. The method as claimed in claim 8, further comprising:
using a powder bed process, selective melting (SLM), and/or selective sintering (SLS) by laser beam or electron beams.

10. The method as claimed in claim 8, further comprising:
using a powder deposition welding process, and/or a laser powder deposition welding process.

11. A product comprising:
an alloy as claimed in claim 1.

12. A nickel-based superalloy, consisting of
the elements (in wt %) of claim 1.
